(19) United States
(12) Patent Application Publication
(10) Pub. No.: US 2023/0132991 A1
(43) Pub. Date: May 4, 2023

(54) SIGNAL TRANSMISSION DEVICE

(71) Applicant: SHIH-KUN YEH, TAIPEI CITY (TW)

(72) Inventor: SHIH-KUN YEH, TAIPEI CITY (TW)

(21) Appl. No.: 17/517,939

(22) Filed: Nov. 3, 2021

(51) Int. Cl. H01B 11/18

(52) U.S. Cl. CPC H01B 11/1852; H01B 11/1869; H01B 11/1895

(57) ABSTRACT

A signal transmission device of the present disclosure has a bus cable, conductive parts and a connection device. The bus cable formed by sequentially stacking a conductor layer, a metal layer and an insulation layer has signal wires. Each of the signal wires has a predetermined width, and each adjacent twos of the signal wires have a predetermined gap therebetween. Each two of the conductive parts have a specific gap therebetween, and each of the conductive part has a first contact terminal and a second contact terminal thereon, wherein the first contact terminals electrically contact the metal layer. The connection device electrically connected to the bus cable has signal conduction wires and ground wires. The signal conduction wires electrically contact the signal wires one by one. The second contact terminals electrically contact the ground wires one by one.

### BACKGROUND

### Technical Field

The present disclosure relates to a technical filed of signal transmission, in particular to, a signal transmission device which improves a grounding structure design to effectively enhance signal transmission efficiency.

### Related Art

A general signal transmission device includes a bus cable (for example, a PCIE bus, a SATA bus and other signal transmission cable used in computers) and connectors respectively arranged at both ends of the bus cable. The connector is electrically connected to the bus cable, and is connected to a corresponding connector of an external device (for example, the corresponding male or female connector), and the signal can be transmitted to the external device through the signal wires in the bus cable and through the connector.

Refer to FIG. 1 and FIG. 2 at the same time. FIG. 1 is a plan view of a conventional bus cable, and FIG. 2 is a cross-sectional view of A-A section of the conventional bus cable shown in FIG. 1. As shown in FIG. 1 and FIG. 2, the conventional bus cable 9 is formed by sequentially stacking a conductor layer 91, foam layer 92, a metal layer 93 and an insulation layer 94, and the conductor layer 91 comprises signal wires 911 and ground wires 912. In the conventional manner, one of the ground wires 912 is arranged between the two adjacent signal wires 911, and by repeating the above arrangement, the bus cable 9 is configured to have a specification width. For example, the bus cable 9 may have the specification width of 48 wires or 72 wires.

As mentioned above, since the conductor layer 91 of the bus cable 9 has the ground wires 912 and the bus cable 9 is under the limitation of the specification width, the width of the signal wire 911 is limited, which may decrease transmission speed. The structure of the bus cable 9 must be designed well, and that is the design should consider the skin effect and the characteristic impedance.

The skin effect is a phenomenon in which the current distribution inside the conductor (such as signal wire 911) is uneven when there is an alternating current or alternating electromagnetic field in the conductor. As the distance from the surface of the conductor gradually increases, the current density in the conductor becomes exponential decay, that is, the current in the conductor will be concentrated on the surface of the conductor. When viewed from a cross section perpendicular to the direction of the current, almost no current flows in the center of the conductor, and current flows only at the surface of the conductor. Simply speaking, the current is concentrated in the skin part of the conductor. Because the skin effect makes the alternating current only pass through the surface of the conductor, the current only produces a thermal effect on the surface of the conductor. For example, in the iron and steel industry, the skin effect can be used to quench the surface of steel to increase the hardness of the surface of the steel. The method of mitigating the skin effect can be, for example, the so-called litz wire, that is, multiple metal wires are twisted with each other so that the electromagnetic field can be more evenly distributed; or the solid wire can be replaced with a hollow wire tube, with insulating materials in the middle.

In addition, the aforementioned characteristic impedance refers to the resistance encountered when a high-frequency signal or electromagnetic wave propagates in a conductor, in ohms. The fluctuation difference of the impedance value in the conductor must be controlled so that the signal can be transmitted at the correct speed. For transmission lines formed by different types of conductors (such as coaxial transmission lines, linear transmission lines, micro-strip transmission lines, coplanar transmission lines, etc.), there will be different impedance calculation formulas. Different design conditions can be changed to achieve impedance control, such as changing the material, thickness, and dielectric coefficient of the foam layer in the transmission line.

In summary, under the above-mentioned principle, by setting different design conditions, the width of the signal wire 91 can be widened as a factor for the signal wire 911 to increase the transmission distance and transmission speed. In other words, the improvement of transmission efficiency is extremely important in today's technological development, so how to make the width of the conventional signal wire 911 under the condition of the specification width of bus cable 9 be widened to improve the transmission efficiency while still maintaining the grounding effect of the bus cable 9 is an urgent issue to be solved.

### SUMMARY

In order to solve the above-mentioned problem of reduced transmission efficiency of the conventional signal transmission device due to the limitation of the specification width of the bus cable, the signal transmission device proposed in the present disclosure uses an improved grounding structure design to widen the width of the signal wire of the bus cable for signal transmission, and thus the signal transmission efficiency can be effectively improved.

The present disclosure provides a signal transmission device at least comprising a bus cable, at least a conductive part and a connection device. The bus cable is formed by sequentially stacking a conductor layer, a metal layer and an insulation layer. The conductor layer comprises a plurality of signal wires, each of the signal wires has a predetermined width, and each adjacent twos of the signal wires have a predetermined gap therebetween. The conductive part has a first contact terminal and a second contact terminal thereon, and the first contact terminal of the conductive part electrically contacts the metal layer. The connection device is electrically connected to the bus cable, and comprises a plurality of signal conduction wires and a plurality of ground wires. A number of the signal conduction wires is equal to a number of the signal wires, the signal conduction wires electrically contact the signal wires one by one. The ground wires electrically contact the conductive part, and the second contact terminal of the conductive part electrically contacts each of the ground wires.

As mentioned above, the signal transmission device proposed in the present disclosure is designed to electrically contact at least a conductive part directly with the metal layer of the bus cable, thereby as a grounding structure design. In other words, the conductor layer of the bus cable can only have the signal wire but have no ground wire. Therefore, even under the limitation of the specification width of the bus cable, the width of the signal wire can be widened, which can effectively improve the signal transmission efficiency.

Optionally, in a non-limited exemplary embodiment, the predetermined width is 0.4 mm through 1.0 mm.

Optionally, in a non-limited exemplary embodiment, the conductive part is a sheet shaped conductive adhesive, and the first contact terminal and the second contact terminal are opposite sides of the sheet shaped conductive adhesive.

Optionally, in a non-limited exemplary embodiment, the bus cable further comprises a dielectric layer with a low dielectric coefficient, and the dielectric layer with the low dielectric coefficient is stacked between the conductor layer and the metal layer, and material of the dielectric layer with the low dielectric coefficient is one of polypropylene (PP), polyethylene (PE), non-woven fabric and polytetrafluoroethylene (PTFE).

Optionally, in a non-limited exemplary embodiment, each of the signal conduction wires electrically contacts one of the signal wires via a connection part, such as a conductive adhesive.

Optionally, in a non-limited exemplary embodiment, a length of each of the signal conduction wires is larger than a length of each of the ground wires.

Optionally, in a non-limited exemplary embodiment, each of the signal conduction wires comprises a long rectangular body part and a rectangular head part connected to the long rectangular body part, wherein a width of the rectangular head part is large than a width of the long rectangular body part, and that is, the rectangular head part is expanded relative to the long rectangular body part in a horizontal axis direction.

Optionally, in a non-limited exemplary embodiment, the bus cable is a flexible flat cable (FFC).

The present disclosure provides a signal transmission device at least comprising a bus cable, conductive parts, a connector and a connection device. The bus cable is formed by sequentially stacking a conductor layer, a metal layer and an insulation layer, wherein the conductor layer comprises a plurality of signal wires, each of the signal wires has a predetermined width, and each adjacent twos of the signal wires have a predetermined gap therebetween. The connector comprises a top part and a bottom part connected to the top part. Each two of the conductive parts have a specific gap therebetween, the conductive parts are disposed between the top part and the bottom part, each of the conductive parts has a first contact terminal and a second contact terminal thereon, and the contact terminals of the conductive parts electrically contact the metal layer. The connection device is electrically connected to the bus cable, and comprises a plurality of signal conduction wires and a plurality of ground wires, wherein a number of the signal conduction wires is equal to a number of the signal wires, the signal conduction wires electrically contact the signal wires one by one, a number of the ground wires is equal to a number of the conductive parts, and the second contact terminals of the conductive parts electrically contact the ground wires one by one.

As mentioned above, optionally, in a non-limited exemplary embodiment, the predetermined width is 0.4 mm through 1.0 mm, the predetermined gap is 0.4 mm through 1.2 mm, and the specific gap is 0.2 mm through 2.7 mm.

Optionally, in a non-limited exemplary embodiment, at least one of the top part and the bottom part has a plurality grooves, each adjacent twos of them are disposed by an interval, a number of the grooves is equal to the number of the conductive parts, and each of the conductive parts is a rod-shaped conductive strip and disposed in corresponding one of the grooves.

Optionally, in a non-limited exemplary embodiment, the top part and the bottom part are rectangles, and one of the top part and the bottom part includes snaps at both ends thereof, other one of the top part and the bottom part includes slots at both ends thereof, and the snap and the corresponding slot are correspondingly engaged with each other.

Optionally, in anon-limited exemplary embodiment, the first contact terminal of each of the conductive parts is in a ridge shape the second contact terminal of each of the conductive parts is in an arc shape.

As mentioned above, optionally, in a non-limited exemplary embodiment, the bus cable further comprises a dielectric layer with a low dielectric coefficient, and the dielectric layer with the low dielectric coefficient is stacked between the conductor layer and the metal layer, and material of the dielectric laver with the low dielectric coefficient is one of polypropylene (PP), polyethylene (PE), non-woven fabric and polytetrafluoroethylene (PTFE)

As mentioned above, optionally, in a non-limited exemplary embodiment, each of the signal conduction wires electrically contacts one of the signal wires via a connection part, such as a conductive adhesive.

As mentioned above, optionally, in a non-limited exemplary embodiment a length of each of the signal conduction wires is larger than a length of each of the ground wires.

As mentioned above, optionally, in a non-limited exemplary embodiment, each of the signal conduction wires comprises a long rectangular body part and a rectangular head part connected to the long rectangular body part, wherein a width of the rectangular head part is large than a width of the long rectangular body part, and that is, the rectangular head part is expanded relative to the long rectangular body part in a horizontal axis direction.

As mentioned above, optionally, in a non-limited exemplary embodiment, the bus cable is a flexible flat cable (FFC).

As mentioned above, optionally, in a non-limited exemplary embodiment, the conductive parts are formed by an integrally formed conductive body, and the integrally formed conductive body is stamped to form the first contact terminals and the second contact terminals.

### BRIEF DESCRIPTIONS OF DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings. All of the drawings of the present disclosure are listed and briefly described as follows.

FIG. 1 is a plan view of a conventional bus cable.

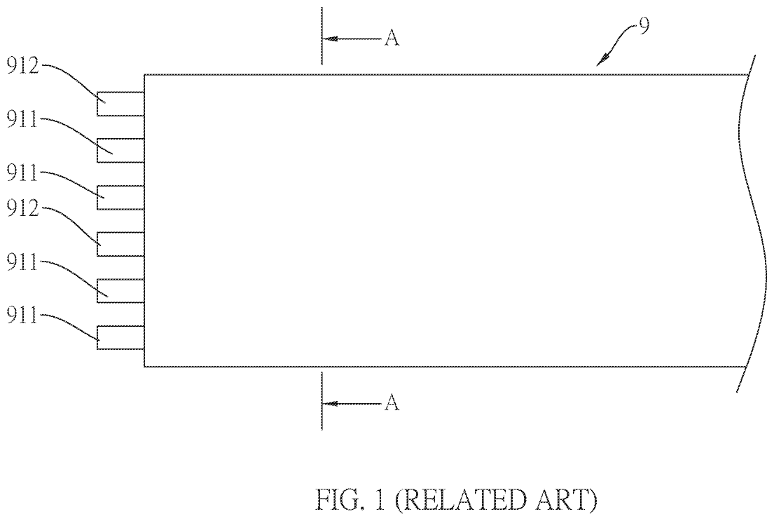

FIG. 2 is across-sectional view of A-A section of the conventional bus cable shown in FIG. 1.

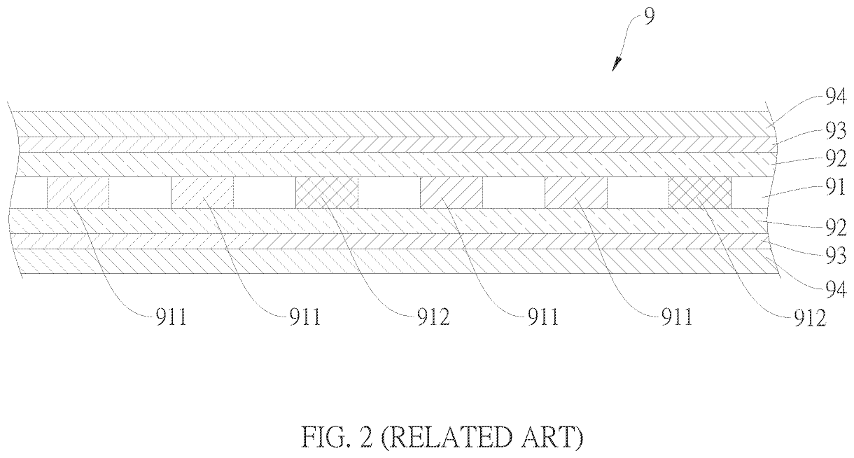

FIG. 3 is an explosive diagram of a signal transmission device according to a first embodiment of the present disclosure.

FIG. 4 is a cross-sectional view of the signal transmission device according to the first embodiment of the present disclosure.

FIG. 5 is a three-dimensional view of a signal transmission device according to a second embodiment of the present disclosure.

FIG. 6 is a three-dimensional view of the signal transmission device observed with another view angle according to the second embodiment of the present disclosure.

FIG. 7A is an explosive diagram of a signal transmission device according to the second embodiment of the present disclosure.

FIG. 7B is an explosive diagram of a signal transmission device with another kind of a conductive part according to another one embodiment of the present disclosure.

FIG. 8 is a cross-sectional view of the signal transmission device according to the second embodiment of the present disclosure.

FIG. 9 is a cross-sectional view of the signal transmission device according to a third embodiment of the present disclosure.

### DETAILED DESCRIPTIONS OF EXEMPLARY EMBODIMENT

While embodiments are described herein by way of example for several embodiments and illustrative drawings, those skilled in the art will recognize that embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims.

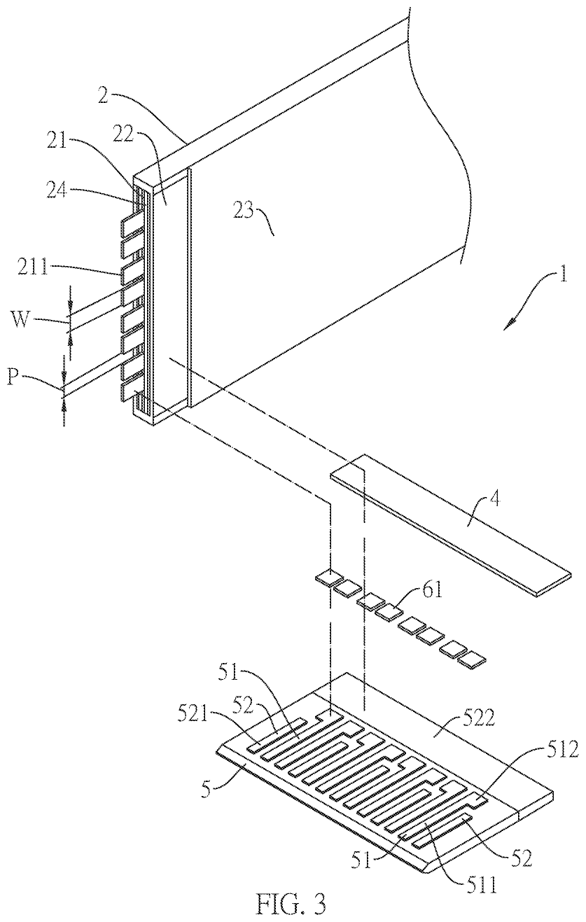

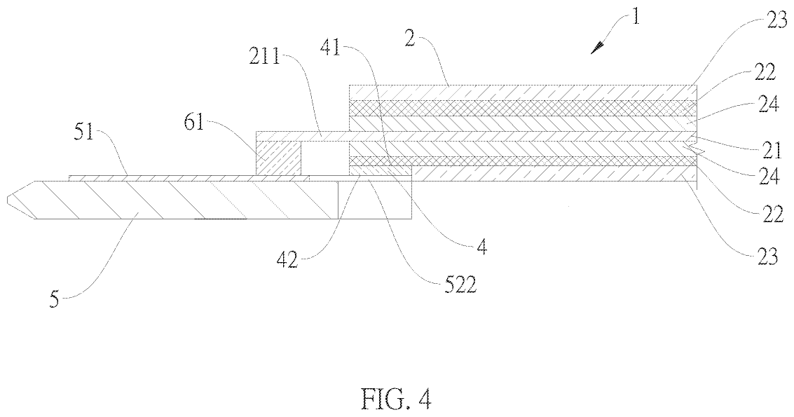

Refer to FIG. 3 and FIG. 4 at the same time. FIG. 3 is an explosive diagram of a signal transmission device according to a first embodiment of the present disclosure, and FIG. 4 is a cross-sectional view of the signal transmission device according to the first embodiment of the present disclosure. The signal transmission device 1 is shown in FIG. 3 and FIG. 4, and comprises a bus cable 2 and at least a conductive part 4.

As shown in FIG. 3 and FIG. 4, the bus cable 2 is formed by sequentially stacking a conductor layer 21, a metal layer 22 and an insulation layer 23, wherein the conductor layer 21 comprises a plurality of signal wires 211, each of the signal wires 211 has a predetermined width W. and each adjacent twos of the signal wires 211 have a predetermined gap P therebetween. The conductive part 4 has a first contact terminal 41 and a second contact terminal 42 thereon, wherein the first contact terminal 41 of the conductive part 4 electrically contacts the metal layer 22 of the bus cable 2.

Equation (I) is used to calculate a characteristic impedance value of the bus cable, and is cited as follows:

$${Z}_{0} = \frac{60}{\sqrt{{ε}_{r}}} \times ln ( \frac{4 ( 2 H + T )}{2.1 ( 8 W + T )} ) , \qquad Equation ( I )$$

wherein Z₀ is the value of the characteristic impedance, εᵣ is a dielectric coefficient, W is the line width, and H is the height of the insulation layer, and T is the thickness of the conductive layer. In the above-mentioned bus cable 2, if the bus cable 2 has the same thickness and the same dielectric coefficient, the wider the line width W of the signal wire is, the better the transmission efficiency is. In other words, in this case, because the bus cable 2 does not have the grounding structure, the line width W of the signal wire can be widened, and the transmission length of the bus cable 2 can be made longer, so that it can improve the transmission efficiency.

Regarding the description of the difference between the embodiment and the comparative example, according to Table 1, the comparative example 1 is a conventional bus cable with ground wire and signal wire, and the signal wire has a line width of 0.3 mm; in one embodiment of the present disclosure, there is no ground wire in the bus cable 2, in addition, depending on the actual structure design needs, the predetermined width W of each of the plurality of signal wires 211 can be between 0.4 mm and 1.0 mm, the predetermined gap P between each twos of the plurality of signal wires 211 may be between 0.4 mm and 1.2 mm. Therefore, in the embodiments 1-4 of the present disclosure, under the premise of the same thickness and the same dielectric coefficient, when the line width W of the signal wire is widened, the transmission length can be made longer, thereby improving the transmission efficiency.

TABLE 1

| bus cable/ | line width | transmission | Possible maximum |
|---|---|---|---|
| signal wire | W(mm) | speed(G/s) | transmission length (M) |
| Embodiment 1 | 0.4 | 6 | 1.0 |
| Embodiment 2 | 0.5 | 6 | 2.0 |
| Embodiment 3 | 0.6 | 6 | 2.5 |
| Embodiment 4 | 0.7 | 6 | 3.0 |
| Comparative | 0.3 | 6 | 0.5 |
| Example 1 | | | |

Further, it can be known from FIG. 3 and FIG. 4 that the signal transmission device 1 in the embodiment further comprises a connection device 5. In the embodiment of the present disclosure, the connection device 5 is a circuit board, and the connection device 5 is electrically connected to the bus cable 2. The connection device 5 includes a plurality of signal conduction wires 51 and a plurality of ground wires 52. Among them, the number of the plurality of signal conduction wires 51 is equal to the number of the plurality of signal wires 211 of the conductor layer 21 of the bus cable 2, and the signal conduction wires 51 electrically contact signal wires 211 one by one. That is, one signal conduction wire 51 and corresponding one signal wire 211 are in electrical contact, for example, through a connection part 61. In a preferred embodiment of the present disclosure, the connection part 61 is preferably solder or conductive adhesive, and the connection part 61 is used for conducting the signal conduction wire 51 and the signal wire 211. In addition, the number of the ground wires 52 is equal to the conductive part 4, and the ground wires 52 electrically contact the corresponding conductive parts 4. The second contact terminals 42 of the conductive parts 4 electrically contact the ground wires 52 one by one. The connection device 5 can be one of a circuit board, a connector, and so on.

In this embodiment, the length of each of the plurality of signal conduction wires 51 of the connection device 5 is greater than the length of each of the plurality of ground wires 52, and the difference in length can form an easily recognizable effect. In addition, in this embodiment, each of the plurality of signal conduction wires 51 of the connection device 5 includes a long rectangular body part 511 and a rectangular head part 512, and both of them connected to each other. A width of the rectangular head part 512 is large than a width of the long rectangular body part 511, and that is, the rectangular head part is expanded relative to the long rectangular body part in a horizontal axis direction. The larger area of the rectangular head part 512 of the signal conduction wire 51 can easily make electrical contact with the connection part 61 to electrically contact the signal wire 211. In another embodiment of the present disclosure, each of the plurality of ground wires 52 of the connection device 5 includes a ground terminal 521 connected to each other, and each of the ground terminals is connected to each other with a ground plane 522. The ground plane 522 and the second contact terminal 42 of the conductive part 4 are in electrical contact, and the first contact terminal 41 of the conductive part 4 is in electrical contact with the metal layer 22 of the bus cable 2 to achieve a ground connection state.

As shown in FIG. 3 and FIG. 4, the conductive part 4 is a sheet shaped conductive adhesive (a rectangular sheet as shown in the drawings) in this embodiment, and the first contact terminal 41 and the second contact terminal 42 are the opposite sides of sheet shaped conductive adhesive. The aforementioned conductive part 4 is in the form of a sheet shaped conductive adhesive in this embodiment, but other methods may also be used, such as soldering with metal shrapnel or solder (i.e. the solder forms the conductive part).

It can be seen from the above that the grounding structure design of the bus cable 2 is directly formed based on the metal layer 22, that is, the grounding structure design is formed by electrically contacting the metal layer 22 of the bus cable 2 and the ground wires 52 of the connection device 5 through the conductive parts 4, respectively. The conductor layer 21 of bus cable 2 can only have the signal wires 211 without the need to set ground wires as in the prior art. On the other hand, without affecting the specification width of the bus cable 2, the signal wires 211 can have more space to widen the width of the signal wires 211, and therefore effectively achieve the purpose of improving signal transmission efficiency.

In this embodiment, the above-mentioned bus cable 2 is a flexible flat cable (FFC), of course, but it is not limited to this. For example, the bus cable 2 may also be a flexible printed circuitry (FPC). In addition, the bus cable 2 may further include a dielectric layer 24 with a low dielectric coefficient, the dielectric layer 24 with a low dielectric coefficient is laminated between the conductor layer 21 and the metal layer 22, and the material of the dielectric layer 24 with the low dielectric coefficient may be poly One of propylene (PP), polyethylene (PE), non-woven fabric or polytetrafluoroethylene (PTFE). In the manufacture of the bus cable 2, the bus cable 2 can also include a film layer or a glue layer, for example, the film layer can be made of PET.

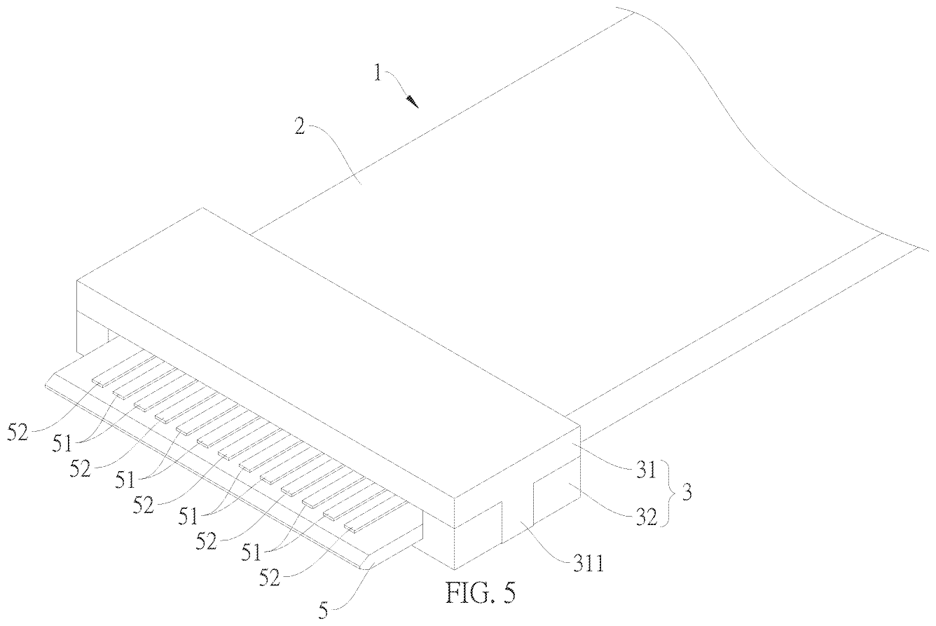

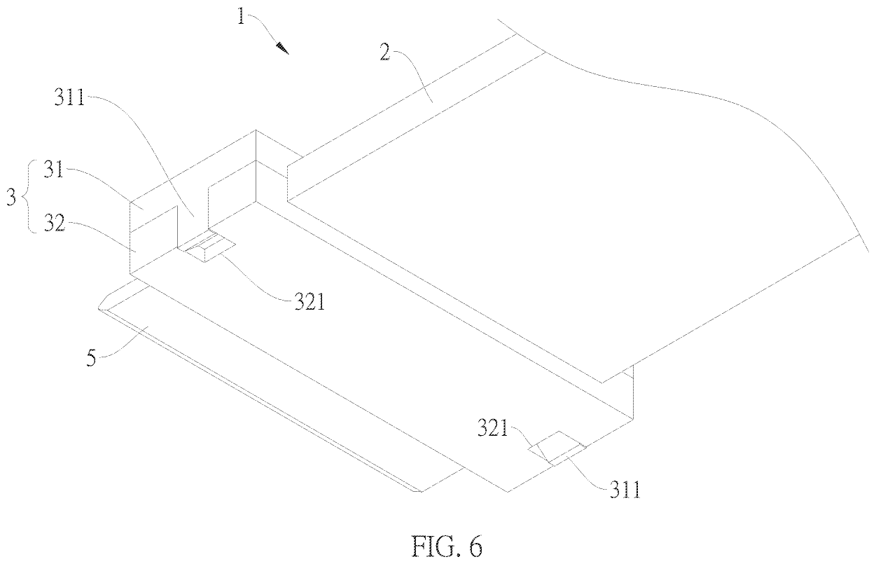

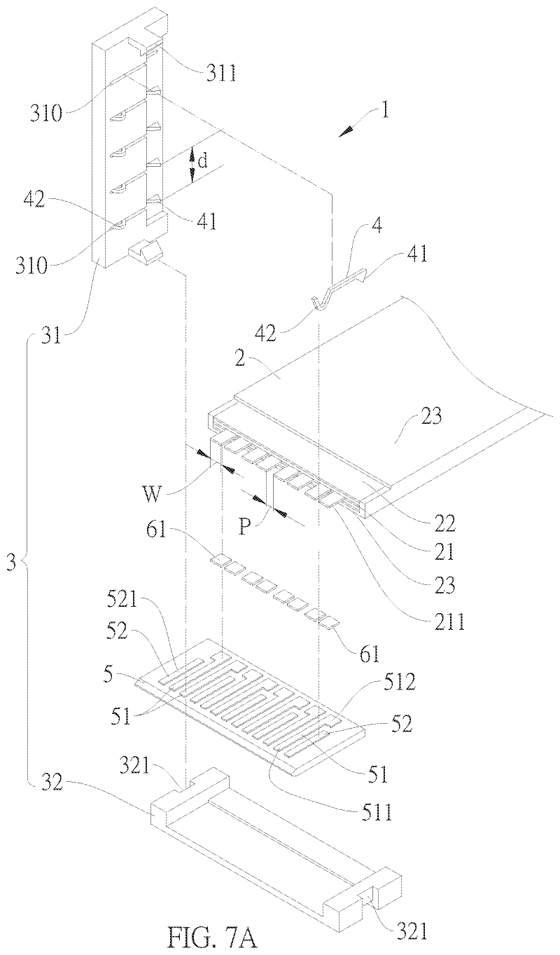

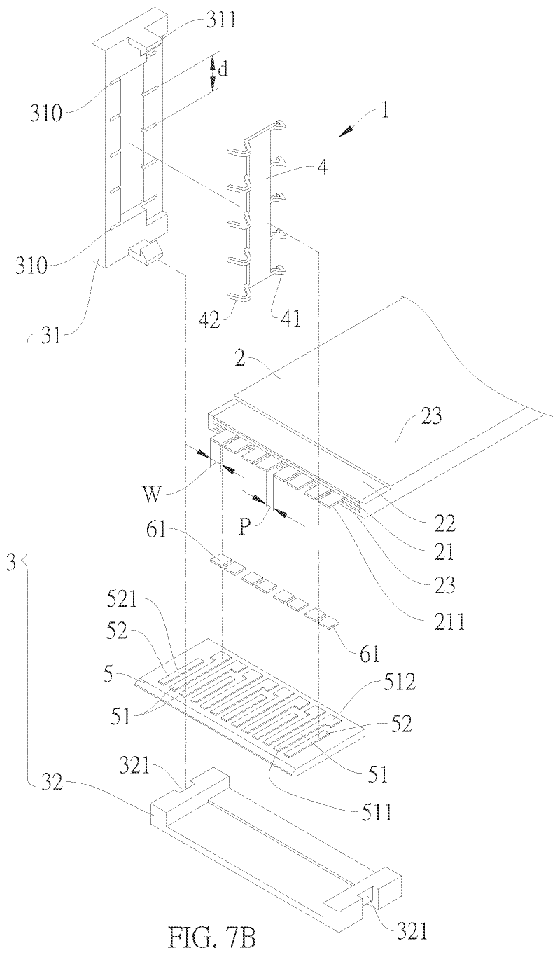

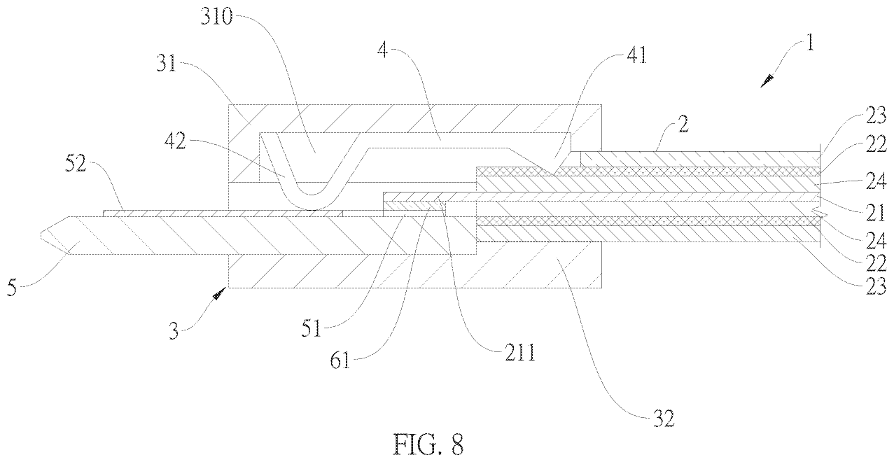

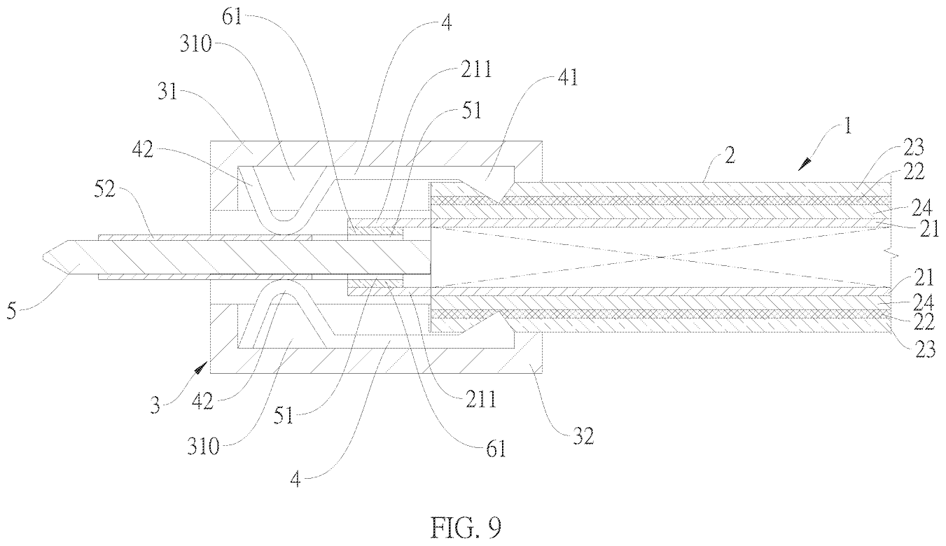

Refer to FIG. 5 through FIG. 9 at the same time, FIG. 5 is a three-dimensional view of a signal transmission device according to a second embodiment of the present disclosure, FIG. 6 is a three-dimensional view of the signal transmission device observed with another view angle according to the second embodiment of the present disclosure, FIG. 7A is an explosive diagram of a signal transmission device according to the second embodiment of the present disclosure, FIG. 7B is an explosive diagram of a signal transmission device with another kind of a conductive part according to another one embodiment of the present disclosure. FIG. 8 is a cross-sectional view of the signal transmission device according to the second embodiment of the present disclosure, and FIG. 9 is a cross-sectional view of the signal transmission device according to a third embodiment of the present disclosure.

In this embodiment, the main structure is the same as the first embodiment, except that the signal transmission device 1 further includes a connector 3, and the connector 3 includes a top part 31 and a bottom part 32 that are joined to each other. Each of the plurality of conductive parts 4 is a rod-shaped conductive strip and is disposed between the top part 31 and the bottom part 32.

Similarly, the connection device 5 is electrically connected to the bus cable 2, and the connection device 5 includes a plurality of signal conduction wires 51 and a plurality of ground wires 52, wherein the number of the plurality of signal conduction wires 51 is equal to the number of the plurality of signal wires 211, and the signal conduction wires 51 are in electrical contact with the signal wires 211 one by one. The number of the ground wires 52 is equal to the number of the conductive parts 4, and the second contact terminals 42 of the conductive parts 4 are in electrical contact with the ground wires 52 one by one.

Like the first embodiment described above, this embodiment uses a conductive part 4 in the form of a rod-shaped conductive strip to electrically contact the metal layer 22 of the bus cable 2 and the ground wires 52 of the connection device 5 to achieve the grounding effect. Similarly, the bus cable 2 does not need to have a ground wire set thereof, so that the width of the signal wire 211 of the bus cable 2 can be widened, thereby achieving the purpose of effectively improving the transmission efficiency.

In the embodiment, the top part 31 includes a plurality of grooves 310 arranged at intervals (of course, a plurality of grooves 310 may also be arranged at intervals of each other in the bottom part 32, or at the same time as the top part 31 and the bottom part 32). The number of the plurality of grooves 310 is equal to the number of the plurality of conductive parts 4, and each of the plurality of conductive parts 4 corresponds to one of the plurality of grooves 310, that is, one conductive part 4 is corresponding to one groove 310. For example, the conductive part 4 can be inserted in a tight-fitting manner to set on the groove 310 to prevent it from falling.

In this embodiment, the top part 31 and the bottom part 32 are respectively elongated rectangles, and the top part 31 (or bottom part 32) includes snaps 311 at both ends, and the bottom part 32 (or top part 31) includes slots 321 at both ends. The snap 311 and the corresponding slot 321 are engaged with each other. Of course, the joining method of the top part 31 and the bottom part 32 is not used to limit the present disclosure, for example, screw locking, bolting, or bonding may also be used.

In order to make it easier for the plurality of conductive parts 4 to electrically contact the metal layer 22 of the bus cable 2 and the ground wires 52 of the connection device 5, in this embodiment, the first contact terminal 41 of each of the plurality of conductive parts 4 is in a ridge shape, the second contact terminal 42 of each of the plurality of conductive parts 4 is in an arc shape. In other words, the ridge-shaped and arc-shaped structure design can make the first contact terminal 41 and the second contact terminal 42 form protruding points, which can make electrical contact with the metal layer 22 of the bus cable 2 and the ground wire 52 of the connection device 5 more conveniently. Of course, the shapes of the first contact terminals 41 and the second contact terminals 42 of the plurality of conductive parts 4 are not limited to the aforementioned ones, and other shapes are also possible, such as a pointed shape, a polygonal shape, and the like. As shown in FIG. 7B, in another embodiment of the present disclosure, the plurality of conductive parts 4 are formed by an integrally formed conductive body (not shown in the drawings), and the integrally formed conductive body is stamped to form the first contact terminals 41 and the second contact terminals 42; accordingly. Thus, the conductive body after stamping can be directly formed on the top part 31 or the bottom part 32 of the connector 3.

Please refer to FIG. 9 again. In another embodiment of the present disclosure, the signal transmission device is composed of two bus cables 2, a connection device 5, and a connector 3. The connection device 5 is a double-sided connection device, and the two surfaces of the double-sided connection device are electrically connected to a structure of the bus cable 2, wherein in both of the up and down directions the bus cable 2 is formed by sequentially stacked a conductor layer 21, a metal layer 22, and an insulation laver 23. The conductor layer 21 includes a plurality of signal wires 211. Each of the plurality of signal wires 211 has a predetermined width W, and each adjacent twos of the plurality of signal wires 211 is separated from each other by a predetermined gap P.

Various modifications and changes may be made as would be obvious to a person skilled in the art having the benefit of this disclosure. It is intended to embrace all such modifications and changes and, accordingly, the above descriptions to be regarded in an illustrative rather than a restrictive sense.

What is claimed is:

1. A signal transmission device, at least comprising:
a bus cable, formed by sequentially stacking a conductor layer, a metal layer and an insulation layer, wherein the conductor layer comprises a plurality of signal wires, each of the signal wires has a predetermined width, and each adjacent twos of the signal wires have a predetermined gap therebetween;
at least a conductive part, having a first contact terminal and a second contact terminal thereon, and the first contact terminal of the conductive part electrically contacts the metal layer; and
a connection device, electrically connected to the bus cable, comprising a plurality of signal conduction wires and a plurality of ground wires, wherein a number of the signal conduction wires is equal to a number of the signal wires, the signal conduction wires electrically contact the signal wires one by one, the ground wires electrically contact the conductive part, and the second contact terminal of the conductive part electrically contacts each of the ground wires.

2. The signal transmission device of claim 1, wherein the predetermined width is 0.4 mm through 1.0 mm, and the predetermined gap is 0.4 mm through 1.2 mm.

3. The signal transmission device of claim 1, wherein the conductive part is a sheet shaped conductive adhesive, and the first contact terminal and the second contact terminal are opposite sides of the sheet shaped conductive adhesive.

4. The signal transmission device of claim 1, wherein the bus cable further comprises a dielectric layer with a low dielectric coefficient, and the dielectric layer with the low dielectric coefficient is stacked between the conductor layer and the metal layer.

5. The signal transmission device of claim 1, wherein each of the signal conduction wires electrically contacts one of the signal wires via a connection part.

6. The signal transmission device of claim 1, wherein a length of each of the signal conduction wires is larger than a length of each of the ground wires.

7. The signal transmission device of claim 1, wherein each of the signal conduction wires comprises a long rectangular body part and a rectangular head part connected to the long rectangular body part, wherein a width of the rectangular head part is larger than a width of the long rectangular body part.

8. A signal transmission device, at least comprising:
a bus cable, formed by sequentially stacking a conductor layer, a metal layer and an insulation layer, wherein the conductor layer comprises a plurality of signal wires, each of the signal wires has a predetermined width, and each adjacent twos of the signal wires have a predetermined gap therebetween;
a connector, comprising a top part and a bottom part connected to the top part;
a plurality of conductive parts, wherein each two of the conductive parts have a specific gap therebetween, the conductive parts are disposed between the top part and the bottom part, each of the conductive parts has a first contact terminal and a second contact terminal thereon, and the contact terminals of the conductive parts electrically contact the metal layer; and
a connection device, electrically connected to the bus cable, comprising a plurality of signal conduction wires and a plurality of ground wires, wherein a number of the signal conduction wires is equal to a number of the signal wires, the signal conduction wires electrically contact the signal wires one by one, a number of the ground wires is equal to a number of the conductive parts, and the second contact terminals of the conductive parts electrically contact the ground wires one by one.

9. The signal transmission device of claim 8, wherein the predetermined width is 0.4 mm through 1.0 mm.

10. The signal transmission device of claim 8, wherein the predetermined gap is 0.4 mm through 1.2 mm

11. The signal transmission device of claim 8, wherein the specific gap is 0.2 mm through 2.7 mm.

12. The signal transmission device of claim 8, wherein at least one of the top part and the bottom part has a plurality grooves, each adjacent twos of them are disposed by an interval, a number of the grooves is equal to the number of the conductive parts, and each of the conductive parts is a rod-shaped conductive strip and disposed in corresponding one of the grooves.

13. The signal transmission device of claim 8, wherein the top part and the bottom part are rectangles, and one of the top part and the bottom part includes snaps at both ends thereof, other one of the top part and the bottom part includes slots at both ends thereof, and the snap and the corresponding slot are correspondingly engaged with each other.

14. The signal transmission device of claim 8, wherein the first contact terminal of each of the conductive parts is in a ridge shape.

15. The signal transmission device of claim 8, wherein the second contact terminal of each of the conductive parts is in an arc shape.

16. The signal transmission device of claim 8, wherein the bus cable further comprises a dielectric layer with a low dielectric coefficient, and the dielectric layer with the low dielectric coefficient is stacked between the conductor layer and the metal layer.

17. The signal transmission device of claim 8, wherein each of the signal conduction wires electrically contacts one of the signal wires via a connection part.

18. The signal transmission device of claim 8, wherein a length of each of the signal conduction wires is larger than a length of each of the ground wires.

19. The signal transmission device of claim 8, wherein each of the signal conduction wires comprises a long rectangular body part and a rectangular head part connected to the long rectangular body part, wherein a width of the rectangular head part is larger than a width of the long rectangular body part.

20. The signal transmission device of claim 8, wherein the conductive parts are formed by an integrally formed conductive body, and the integrally formed conductive body is stamped to form the first contact terminals and the second contact terminals.
